(19) United States
(12) Patent Application Publication
(10) Pub. No.: US 2012/0116703 A1
(43) Pub. Date: May 10, 2012

(54) METHOD AND APPARATUS FOR ENHANCED SPATIAL BANDWIDTH WAVEFRONTS RECONSTRUCTED FROM DIGITAL INTERFEROGRAMS OR HOLOGRAMS

(76) Inventors: Nicolas Pavillon, Lausanne (CH); Chandra Sekhar Seelamantula, Hyderabad (IN); Michael Unser, Ecublens (CH); Christian Depeursinge, Preverenges (CH)

(21) Appl. No.: 13/266,027

(22) PCT Filed: Apr. 23, 2010
(86) PCT No.: PCT/IB2010/051801

§ 371 Date: Jan. 17, 2012

(30) Foreign Application Priority Data
Apr. 24, 2009 (IB) PCT/IB2009/051683

(51) Int. Cl. G06F 19/00

(52) U.S. Cl. 702/70

(57) ABSTRACT

The present invention discloses a method and an apparatus to compute a complex wavefield, referred to as the object wave o, by means of measuring the intensity signal resulting from the interference of the said object wave with a second wave termed the reference wave. The second wave r is assumed to have some non-vanishing mutual coherence with the said object wave o. The reference wave can be obtained from a source or from the object wave itself. The wave may be emitted from sources of variable degree of coherence and can be scattered waves, but also light-emitting molecules, matter waves such as electron beams or acoustical sources. The disclosed method relates to the said “non-linear method” (NLM). The innovation resides in the fact that the NLM improves considerably the bandwidth of the wavefront reconstructed from off-axis interferograms and holograms obtained in a single shot. The advantage is the significant improvement of the resolution of the images obtained from the reconstructed wavefront, i.e. amplitude and phase images. The said method also suppresses the artifacts resulting from the intensity recording of interferograms and holograms. The method is general in the sense that it can be used for any interferometric measurement, provided that it satisfies the simple requirement that the intensity of the reference wave is larger than the intensity of the object wave, and that the object wave modulated by the reference is confined to at least a quadrant of the spectrum. The disclosed method applies to interferometry, holography in optics, electron waves and acoustics. In particular, it can be implemented in phase, fluorescence, luminescence, electron and acoustic microscopy.

### FIELD OF THE INVENTION & STATE OF THE ART

The present invention discloses a method and an apparatus to compute the complex object wavefield o by means of measuring the intensity signal resulting from the interference of the said wave o with a second wave r, this second wave having some non-vanishing mutual coherence with the said object wave. In its most general implementation, the apparatus comprises a device generating a wave, which will be analyzed by the measurement of the intensity of the wave resulting from the interference of the said “wave” o with the said “second wave” r. This description of the invention includes in particular holography, which describes a method of reconstructing complex-wave from a hologram formed by the interference of an object wave o and a reference wave r considered as the second wave. The basic approach of holography assumes that the object wave o originates from the scattering of a wave from an irradiating source and that the reference wave r is derived from the same irradiating source, by optionally transforming it with beam shaping elements (BSE). The reach of the method and apparatus is however broader than holography in general because the so-called “second wave” r may be also derived from the said object wave o by transforming the wave with beam shaping elements. In the following, the said “wave” will be designated as “object wave” and the said “second wave” will be designated as the “reference wave”.

Most generally these beam shaping elements are mirrors or beam splitters, but also elements which change the space-bandwidth characteristics of the beam such as lenses (spherical, aspherical, cylindrical), prisms, diaphragms, pinholes, forming spatial filters, and also diffracting elements, like gratings, and combinations of these elements. This scheme goes beyond the conventional holographic method and covers the more general field of interferometry. Three illustrative examples will be treated in more details.

The nature of the waves is also diverse: electromagnetic waves including light waves (IR, visible, UV and Far and extreme UV, X-rays) but also matter waves like electron or ion beams, and acoustic waves like ultrasounds or seismic waves.

The coherence requirements are also diverse. For example, in microscopy, weak coherence is most often sufficient. The coherence can be restricted either or both in the temporal or in the spatial domain. The basic rule is that the extent of the coherence either in the temporal or in the spatial domain must be sufficient to provide a contribution of the mutual coherence terms, which correspond to the so-called “cross terms” in the development of the interference of the object and reference wave, all over the surface of the detector array. To reach such a coherence extent, some particular BSE can be used, such as interference filter and Fabry-Pérot interferometers and etalons in the temporal case, or such as spatial filters, pinholes and diffusers in the spatial case.

A new method of processing the intensity of the interfering waves is disclosed: a method is claimed which consists in computing the logarithm of the normalized intensity of the interference wave, calculated as the ratio of the intensity of the interference wave i to the intensity of the reference wave r. Then, the complex 2D Discrete Fourier Transform of the matrix of the logarithm of the normalized intensity of the interference wave, regularly sampled on a plane intercepting the said wave. Next, an algorithm is disclosed which permits to retrieve the complex ratio of the said wave complex amplitude to the secondary wave complex amplitude. Finally, a calculation method is given, to provide the complex amplitude of the said wavefield.

The objective of the present invention is to develop efficient algorithms for improving the resolution of complex-wave reconstruction in holography and more generally in interferometry, by suppressing artifacts generated during hologram recording. These artifacts are a natural consequence of the fact that it is only possible to record intensities. The artifacts appear in the reconstructed holograms and are referred to as the zero-order and the twin image. The so-called zero-order corresponds to the intensity of the object and reference beams used during measurements. The twin-image term carries redundant information, distributed over different orders of diffraction. In off-axis holography, those different terms are separated spatially, in order to allow for filtering of the desired information. This method implies that a large part of the spectral bandwidth of the detector is used by terms that carry redundant information, not useful for reconstruction. This drawback therefore greatly reduces the available bandwidth for the imaging order, and can potentially lead to degradation in its resolution. Furthermore, when spectral overlap occurs, some artifacts can appear in the images. The main objective of the present invention is to improve the efficiency of bandwidth usage for imaging, by suppressing the zero-order term through nonlinear filtering, and thus improving the resolution of reconstructed images.

The fact of recording intensities to reconstruct a complex wavefield implies that artifacts are generated, which are the so-called zero-order, corresponding to the intensity of the beams employed to make interference, and the twin-image, which is a conjugate of the desired image, and thus does not carry any additional information. In the state of the art, we observe that two main classes of methods have been developed to address this issue. The first class is phase-shifting techniques, which rely on the acquisition of several frames, in order to suppress the artifacts by appropriate combination of the holograms taken in a time sequence. The second is off-axis holography or interferometry, which uses only one acquisition, and separates the different orders appearing in the Fourier decomposition of the hologram where the imaging orders appear as spatially modulated. Their separation is therefore possible in the spatial frequency domain of their respective spectra from the zero-order contribution. The drawback of this method is that the bandwidth available for the imaging orders is greatly decreased by the need to spectrally separate the different terms under conventional sampling conditions.

Dating back to the first developments of holography by D. Gabor in “A new microscopic principle,” Nature, 161, 777-778 (1948), the issue of separating the different diffraction orders contained in the reconstruction of a hologram was addressed. The different terms are a consequence of the fact that a complex wavefront is encoded in the measured intensity. The measurements are typically made on a medium or by a digital device as in the state of the art. The diffraction orders comprise the zero-order term corresponding to intensities of the reference and object waves and two imaging terms, which carry identical information. E. N. Leith and J. Upatnieks proposed in “Reconstructed wavefronts and communication theory,” J. Opt. Soc. Am., 52, 1123-1130, (1962) to separate the orders by inserting an angle between the two beams used during measurement, in the now called off-axis configuration, where the different terms can be spatially separated through the different propagation directions induced by the angle between the two beams This issue was present during the first digital developments, when J. Goodman and R. Lawrence acquired for the first time a hologram with a digital detector in “Digital image formation from electronically detected holograms,” Appl. Phys. Lett., 11, 77-79 (1967).

Up until now, two main classes of methods were used to suppress these “artifacts”. On one side, filtering methods were further developed for off-axis configuration by M. Takeda et al., in “Fourier-transform method of fringe-pattern analysis for computer-based topography and interferometry,” J. Opt. Soc. Am., 72, 156-160, (1982). They proposed to suppress the zero-order by high-pass filtering, and subsequently retaining only one of the orders. This enabled digital phase measurements, first made by U. Schnars in “Direct phase determination in hologram interferometry with use of digitally recorded holograms,” J. Opt. Soc. Am. (A), 11, 2011-2015, (1994), wherein the phase between the normal and deformed state of a sample could be measured. Phase measurement was patented in U.S. Pat. No. 6,262,818 and WO 00/020929. The application of the phase measurement technique for phase-contrast imaging was demonstrated by E. Cuche et al. in “Digital holography for quantitative phase-contrast imaging,” Opt. Lett., 24, 291-293, (1999). Further developments in the filtering technique between orders were shown in E. Cuche et al., “Spatial filtering for zero-order and twin-image elimination in digital off-axis holography,” Appl. Opt., 39, 4070-4075, (2000).

The other class of techniques is based on the acquisition of multiple holograms with a certain phase-offset from one measurement to another (I. Yamaguchi and T. Zhang in “Phase-shifting digital holography,” Opt. Lett., 22, 1268-1270, (1997)). The measured holograms are then combined appropriately to suppress the zero-order and the twin image. Several algorithms of frame combination were developed in the following years, based on the same principle.

Different approaches for suppressing the zero-order were proposed. Some are based on subtracting the average of the interferogram, as proposed by T. M. Kreis and J. P. O Jüptner in “Suppression of the dc term in digital holography,” Opt. Eng. 36, 2357-2360 (1997), or by using a high-pass filter as proposed by M. Takeda et al. In general, these methods do not provide perfect reconstruction, since the operations involved are global, and thus can alter the cross-terms, and therefore inducing artifacts in the reconstruction. Recently, new methods were proposed to suppress the artifacts, essentially aiming at reconstructing with only one frame, while relaxing the requirements of the off-axis configuration to separate the orders in the spatial frequency domain. More specifically, E. Garbusi et al. proposed in “Single frame interferogram evaluation,” Appl. Opt., 47, 2046-2052, (2008) a method which can be considered as a spatial frame combination, instead of temporal as done previously. The drawback is that the applicability of the technique is limited to smooth objects only, which implies a drastic reduction of the reconstructed wave-bandwidth. J. Weng et al. proposed a wavelet-type algorithm for suppressing the zero-order and the twin-image in “Digital reconstruction based on angular spectrum diffraction with the ridge of the wavelet transform in holographic phase-contrast microscopy,” Opt. Express, 16, 21971-21981 (2008), by employing an approximation at first order of a Taylor development. Another method proposed by Zhang et al. uses the logarithm operator in the context of inline holography for phase-shifting (Y. Zhang et al., “Reconstruction of in-line digital holograms from two intensity measurements,” Opt. Lett. 29, 1787-1789 (2004)). However, this method is only neglecting terms by employing this operator, and does not rely on the method disclosed in this document.

### SUMMARY OF THE INVENTION

The proposed method is in the context of both imaging interferometry, in particular lateral shearing interferometry, and off-axis holography. It relies on nonlinear filtering in the spatial frequency domain, which enables perfect suppression of the zero-order and twin image, even in case of overlap between the zero-order and the higher orders during hologram acquisition.

A new method of processing the intensity of the interfering waves is disclosed: a calculation method is claimed which consists in computing the logarithm of the normalized intensity of the interference wave, calculated as the ratio of the intensity of the interference wave to the intensity of the second wave or reference wave r. Then, the complex 2D Discrete Fourier Transform of the matrix of the logarithm of the normalized intensity of the interference wave, regularly sampled on a plane intercepting the said wave. Next, an algorithm is disclosed which permits to retrieve the complex ratio of the said wave complex amplitude to the secondary wave complex amplitude. Finally, a calculation method is given, to provide the complex amplitude of the said wavefield.

The main innovation brought by the disclosed method is, in comparison to the state of the art, the significant increase of the spatial bandwidth of the reconstructed wavefield and therefore the substantial amelioration of the resolution of the image obtained from the reconstructed wavefront. A major aspect of the invention is that it also reduces the artifacts in amplitude and phase images that are commonly generated in the state-of-the-art methods. Since the proposed invention is based on the off-axis configuration, it permits one-shot feature, i.e. all the data needed for wavefront reconstruction can be derived from a single hologram taken in a short acquisition time, as short as the detector array or pulsed source permits. The present invention suppresses the zero-order and accordingly the spatial bandwidth is significantly increased. The elimination of the twin image is further achieved by the separation of the spectrum of the imaging order which can be filtered out during reconstruction. The method allows for automatic filtering without manual intervention because the zero-order defines a well-characterized region in the Fourier plane where the imaging order is contained.

The method is based on the fundamental models for wave interference, meaning that the method is general, and can be applied to any interferometric setup, provided that it satisfies the hypotheses required by the method. Under those conditions, the disclosed method provides an exact reconstruction without having to rely on approximations. Furthermore, the proposed invention yields quantitative information about the complex wavefront, implying that any wavefront processing can also be applied after using this technique.

When noise affects the experimental system, only partial suppression of the zero-order may be achieved. It is however possible to fully suppress it by post-processing, such as conventional filtering. In case of critical experimental conditions, where the proposed method does not provide perfect reconstruction, the effectiveness of the proposed method is further enhanced by an iterative process, which is disclosed in the second part of the patent.

### BRIEF DESCRIPTION OF THE DRAWINGS

A detailed description of the elements of the present invention, together with a detailed description of the embedded artwork is given below. It must be emphasized that the drawings are solely for the purpose of illustration and do not in any way limit the scope of the invention.

FIG. 1 is a schematic diagram describing the building blocks of a measurement apparatus according to the present invention, by showing the functional blocks of the generic measuring apparatus. The box describing the generation of the reference wave describes both options: either generating the reference wave from the source, or generating the reference wave from the object wave, as detailed in FIG. 2.

FIG. 2 shows diagrammatically the method employed to generate the interference inside the apparatus. FIG. 2a illustrates the first principle where the reference wave is derived from the irradiating source through Beam Shaping Elements. The hologram is formed as the interference of object wave and interference wave. FIG. 2b illustrates the second principle, where the reference wave is derived from the object wave through Beam Shaping Elements. In that case, the interferogram is formed as the interference of object wave and interference waves. In this case the object field can be directly produced by light-emitting molecules, i.e. fluorescence or luminescence of the object.

FIG. 3 is a representation of the off-axis configuration featuring the wave o or object waves o and the second wave r or reference wave r interfering on the acquisition device or camera.

FIG. 4 is a representation of the spectral domain for an interferometric measurement. FIG. 4a shows the loss of bandwidth with classical reconstruction, where the zero-order is utilizing a major part (approximately one third) of the bandwidth, while not carrying any additional or useful information. FIG. 4b shows how the spectra of the various orders can be accommodated within the available bandwidth, when the zero-order is suppressed using the proposed technique. In FIG. 4c, the design of the quadrant filter 604 is shown graphically.

FIG. 5 shows possible experimental setups related to the present invention. FIG. 5a shows a Digital Holographic Microscope in a Reflection configuration; FIG. 5b depicts a Digital Holographic Microscope in a Transmission configuration; FIGS. 5c and 5d depict an imaging interferometer configuration: a Lateral Shearing Interferometer. The reference beam is identical to the object beam sheared in space or in angular propagation. Optional Beam Shaping Elements can be added such as spatial filter or interference filter to increase the coherence length of fluorescent or luminescent objects.

FIG. 6 shows diagrammatically the steps of the non-iterative reconstruction method.

FIG. 7 brings a proof of principle of the proposed non-linear reconstruction method, where a biological cell, which is essentially a phase object, was measured in transmission. FIG. 7a is the amplitude signal in case of the present state-of-the-art reconstruction, where the effect of the zero-order can be readily seen in the upper-right corner. The artifacts are suppressed in the case of reconstruction by the nonlinear technique reconstruction, shown in FIG. 7b. The artifact suppression can also be seen in the phase image, by comparing the present state-of-the-art reconstruction in FIG. 7c and the one obtained with the nonlinear method in FIG. 7d.

FIG. 8 is a second demonstration of the artifact suppression, in the case of a reflection measurement. The amplitude and phase of the classical reconstruction (respectively in FIG. 8a and FIG. 8c) contain irregularities and artifacts, which are suppressed by the nonlinear technique, both in amplitude (FIG. 8b) and in phase (FIG. 8d). FIG. 8e shows the selected quadrant of the Fourier transform of the hologram, where spatial frequencies of the zero-order can be seen in the lower-right corner. Those components are greatly attenuated by the nonlinear method, as shown in FIG. 8f.

FIG. 9 is a demonstration of use of the nonlinear method for rough samples, where a letter on a coin has been measured in reflection. In this case, the zero-order artifact is clearly identifiable in the standard reconstruction in FIG. 9a, which is suppressed by employing the nonlinear method, as shown in FIG. 9b. The relevant quadrant of the spectra of the reconstructions are shown in FIG. 9c and FIG. 9d, respectively for the standard and nonlinear method, showing that the zero-order is suppressed in the latter case.

FIG. 10 is a flowchart of the iterative technique for complex-wave reconstruction from the logarithm of the measurements.

FIG. 11 is a flowchart of the iterative technique for complex-valued object-wave retrieval from the magnitude spectrum.

FIG. 12 illustrates the formation of the interferogram or hologram of a punctual source S in off-axis holography and in a Lateral Shear Interferometer (according to FIG. 5d); the punctual source can be a scatterer or an emitter. FIG. 12a left: the image of the punctual source forms, after division of the wavefront by the beamsplitter, two punctual sources S1 and S2, which are sources of spherical waves which interfere. The result of this interference is a standing wave with minima and maxima forming hyperboloids (FIG. 12a, right) in space with the axis along S1-S2. FIG. 12b shows the limiting case where the tilt angle of the shearing mirror is zero. The role of the position of the shearing mirror or, more generally of the Beam Shaping Elements, involved in the formation of the reference wave, can be just a delay or a displacement along the optical axis z. In this case the hologram or interferogram is a Fresnel pattern. The second sketch of FIG. 12b shows the other extreme case where the axis S1-S2 is perpendicular to the optical axis z. The family of hyperboloids intercepts the detector array forming a family of hyperbola. If S1 and S2 are far enough from the detector array, the family of hyperbola becomes parallel lines, as shown in the third sketch of FIG. 12b. On the contrary, the case of S1-S2 close or touching the detector array is illustrated in FIG. 12c: the hyperboloids become at the limit cones intercepting the detector plane as a family of lines, the angle of which can be used to measure the distance between S1 and S2.

### DETAILED DESCRIPTION OF THE INVENTION

The details of a new method of processing the intensity of the interfering waves, shortly referred as the “nonlinear method” (NLM) is disclosed: a method is claimed which consists in computing the logarithm of the normalized intensity of the interference wave, calculated as the ratio of the intensity of the interference wave to the intensity of the second wave or reference wave r. Then, the complex 2D Discrete Fourier Transform of the matrix of the logarithm of the normalized intensity of the interference wave, regularly sampled on a plane intercepting the said wave. Next an algorithm is disclosed which permits to retrieve the complex ratio of the said object wave complex amplitude to the secondary wave or complex amplitude. Finally, a calculation method is given, to provide the complex amplitude of the said wavefield.

The main innovation brought by the disclosed method is, in comparison to the state of the art, the significant increase of the spatial bandwidth of the wavefield reconstructed from off-axis interferograms and holograms. The benefit is therefore the substantial amelioration of the resolution of the amplitude and phase images obtained from the reconstructed wavefront.

The apparatus designed according to the requirements of the method are described subsequently.

Most generally, the apparatus generates and records the interference pattern or hologram of any kind of waves, which may be an electromagnetic wave—either in the microwave, optical or UV, X-ray, gamma spectral range, or possibly matter waves, such as electron waves, or acoustic waves, or basically any kind of waves propagating in the near or far-field. The interference of two such waves, known as the wave o or object wave, which interacts with the measured sample, and the second wave r or reference wave, is collected on a detector array which transmit the intensity data to the computer which will process the data according to the disclosed method. The so-called waves can be planar, spherical, or any other well-characterized wave generated by the source, the object or the second wave or reference wave generator.

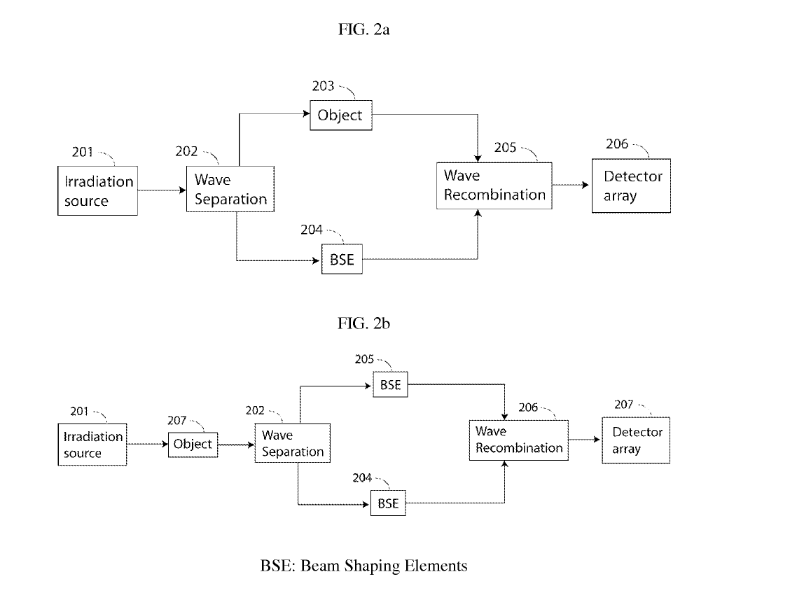

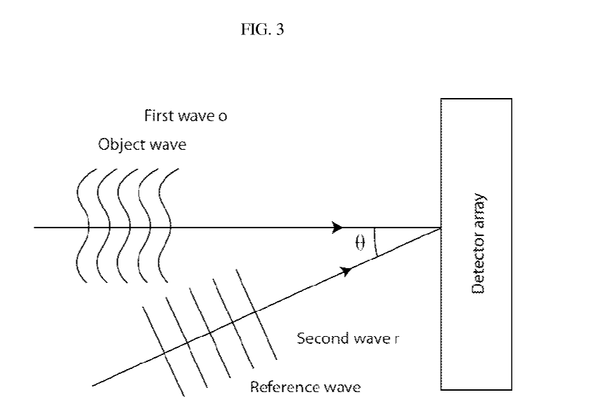

The present invention discloses a method and an apparatus to compute a complex wavefield o by means of measuring the intensity signal resulting from the interference of the said wave o with a second wave r, this second wave having some non-vanishing mutual coherence with the said wave. As illustrated in FIG. 2a the apparatus comprises, in its most general implementation, a device generating a wave, which will be analyzed by the measurement of the intensity of the wave resulting from the interference of the said “wave” o with the said “second wave” r. This description of the invention includes in particular holography, which describes a method of reconstructing complex-wave from a hologram formed by the interference of an object wave o and a reference wave r considered as a second wave. The basic approach of holography assumes that the object wave o originates from the scattering of a wave from an irradiating source and that the reference wave r is derived from the same irradiating source, by optionally transforming it with beam shaping elements (BSE).

Most generally these beam shaping elements BSE are mirrors or beam splitters, but also components which change the space-bandwidth characteristics of the beam such as lenses (spherical, aspherical, cylindrical), prisms, diaphragms, pinholes, forming spatial filters, diffracting elements, like gratings, and combinations of these components. The examples of such implementations are given for the case of Transmission and Reflection Digital Holographic Microscopes. BSE also provide a mean to delay the wave in time. BSE can also include spectral filters such as interference filters, air spaced or solid etalons, or Fabry-Pérot interferometers.

As illustrated in FIG. 2b, the reach of the method and apparatus is broader than holography in general, because the so-called “second wave” r may be also derived from the said object wave o by transforming the wave with beam shaping elements (BSE) according to the description of BSE given in the last paragraph. This scheme goes beyond the conventional holographic method and covers the more general field of interferometry. The example of Shearing Interferometers will be given.

The nature of the waves is also diverse: the waves may be electromagnetic waves including light waves (IR, visible, UV and Far and extreme UV, X-rays) or matter waves like electron or ion beams, and acoustic waves like ultrasounds or seismic waves.

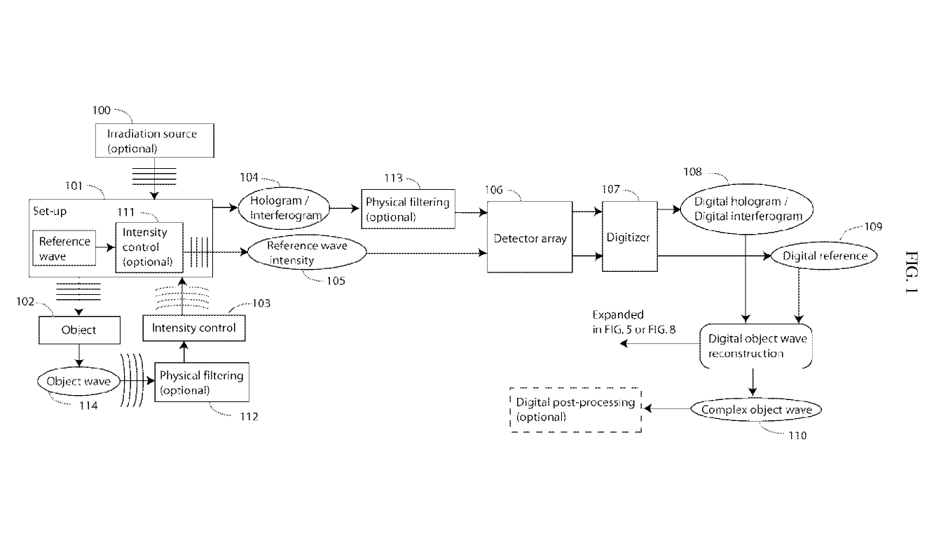

FIG. 1 shows a block diagram featuring the main functionalities of the apparatus required to implement the said “non linear filtering technique”.

In a first embodiment, the irradiating source 100 irradiates directly or sends a beam to the setup 101, which irradiates an object 102. The said wave object is then conducted back to 101 where it creates a hologram 104 by interfering with a reference wave, which, in this first embodiment, is derived from the irradiating source, by using optional beam shaping elements BSE.

In a second embodiment, as for the first embodiment, the irradiating source 100 irradiates directly or sends a beam to a setup 101, which irradiates, an object 102. The wave, said object wave, is then conducted back to 101 where it creates a hologram 104 by interfering with a reference wave which, in this second embodiment, is derived from the object wave itself, by using optional beam shaping elements BSE.

For the first and second embodiment, the interaction of the source wave with the measured sample can be done in two modes: 1) reflection geometry, where the wave o is reflected by the object, giving information about its shape if it is highly reflective, or its internal structure through back-scattering phenomena if it is mainly transparent within the employed spectral range; 2) transmission geometry, where the wave is diffracted by the sample, giving information about its internal structure.

In a third embodiment, the irradiating source 100 is optional: as for the second embodiment, the wave, said object wave, is conducted to 101 where it creates a hologram 104 by interfering with a reference wave which, in this third embodiment, is also derived from the object wave itself, by using optional beam shaping elements BSE. An independent irradiating source is not necessary and can be considered as confounded with the object: this is the case of optics, if one considers fluorescent emitters like fluorophores, chemi- or thermo-luminescent emitters: luminophores. Acoustical emitters are also relevant.

There is no specific requirement on the kind of irradiating source, so that any source providing coherent or partially coherent waves, such as electromagnetic sources: microwave sources, teraherz sources, or in optics: LEDs, superluminescent diodes, laser diodes, or more generally any laser, gas laser, solid state lasers, or in high energy spectral range: UV, Extreme UV, X-ray sources, matter waves emitter: electron or even ion or neutron emitters Another important field is acoustic sources, ultrasounds or infra-sounds emitters can be employed.

The access of the complete wavefield enables the access to the 3-dimensional information around the measurement plane, by propagating this wavefield with a given propagation model, such as, in the case of an optical wavefield, the Fresnel-Kirchhoff integral, the Fresnel approximation, or any algorithm based on the Huygens-Fresnel principle and the associated integral formulation.

The coherence requirements are diverse: in microscopy, weak coherence is most often enough. The coherence can be restricted both in the temporal and in the spatial domain. The basic rule is that the extent of the coherence both in the temporal and in the spatial domain must be sufficient to provide a contribution of the mutual coherence terms corresponding to the so called “cross terms” in the development of the interference of the object and reference wave, all over the surface of the detector array. In the third embodiment, where optical emitting molecules, fluorophore or luminophores, are considered, an optical filter, interference filter, filter band-stop, Fabry-Pérot interferometers or etalons can be inserted before the interferogram formation, or before the camera, in order to increase the coherence length.

The hologram is created by the interference between the said “wave” o (object wave), which interacts with the sample 102 and a second wave r or reference wave generated by the setup 101. As described for the different embodiments, the box of 101 describing the generation of the reference wave or more generally, the second wave describes both options: either generating the reference wave directly from the source, or generating reference wave from the object wave o, as shown in FIG. 2.

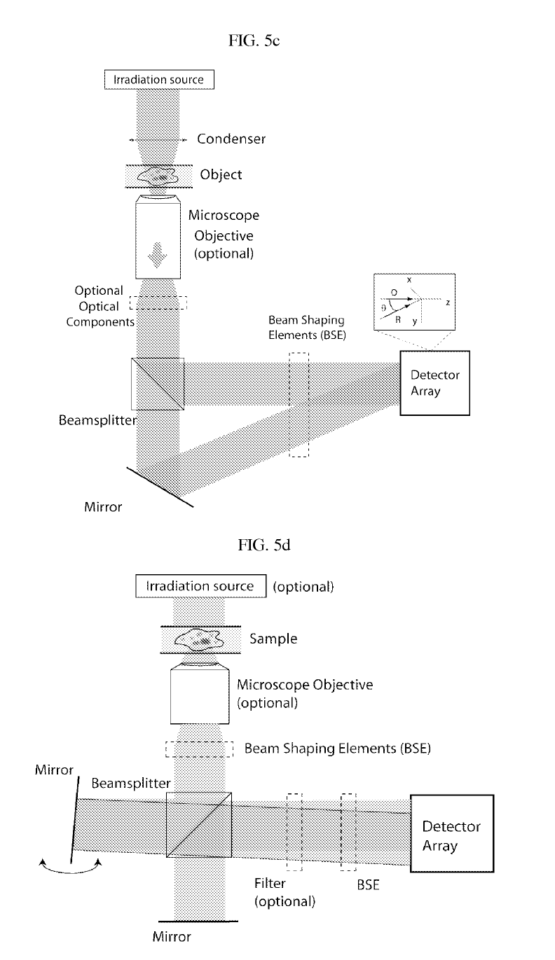

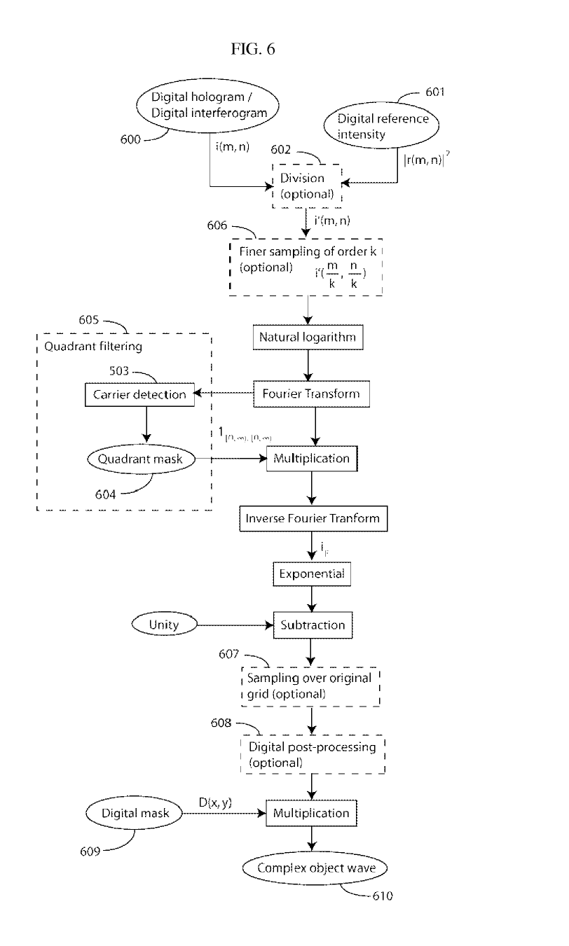

It is possible to control the object beam intensity with an intensity control device 103. In optics, the intensity control can be implemented by inserting neutral density filters, or by using polarization optics, or by any other means of enabling intensity changes. The setup 101 also enables the measurement of the intensity of the reference wave 105. Similarly, an alternative could be to control the reference beam intensity with an intensity control device 111 placed at the output of the “reference wave” box. The hologram 102 and the reference intensity 105 are measured with an acquisition device 106. The acquisition can be performed by any kind of detector array, such as a charge-coupled device (CCD) camera or by a complementary metal oxide-semiconductor (CMOS) detector for optics, the same with scintillators for electron or ion beams detectors or an array of piezo-electric detectors or capacitive detectors for acoustics. Preference should be given to the camera having a large dynamical range, possibly with control of gain, in particular for EMCCD cameras. The measurement is then quantized by an image digitizer 107, giving rise to a digital hologram 108 and a digital reference intensity 109. The digital images are then used to reconstruct the complex object wave 110, carrying information about the amplitude and the phase of the object wave. The details of the reconstruction are expanded in FIG. 6 and given below.

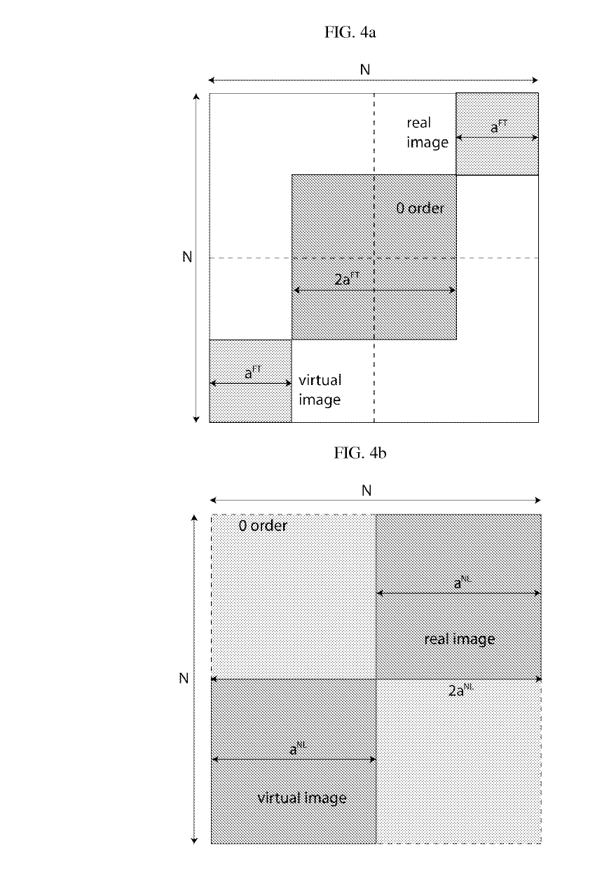

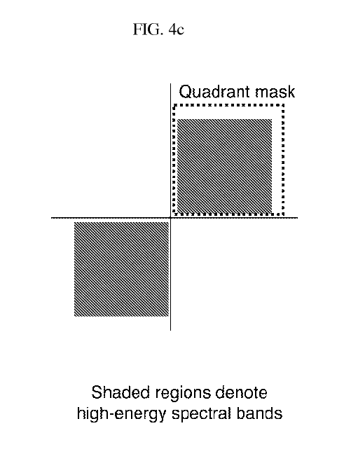

In the proposed invention, the off-axis configuration is employed. The principle behind this configuration is illustrated in FIG. 3. The angle between the two beams modulates the last two terms of Eq. (1). As a result, they are spectrally separated and can therefore be suitably filtered in the spatial frequency domain, as shown in FIG. 4a. A detailed description of this technique is available in E. Cuche et al., in “Spatial filtering for zero-order and twin-image elimination in digital off-axis holography,” Appl. Opt. 39, 4070-4075 (2000) and the patents U.S. Pat. No. 6,262,818 and WO 00/020929.

Let us now address the core of the invention. The interference of the two waves: o and r is commonly measured digitally with an array detector and acquisition device. The measured intensity i(x, y), corresponding to the interference pattern, is given by:

$$\begin{matrix}i ( x , y ) = {\vert o ( x , y ) + r ( x , y ) \vert}^{2} \\ = {\vert r ( x , y ) \vert}^{2} + {\vert o ( x , y ) \vert}^{2} + {r}^{*} ( x , y ) o ( x , y ) + {o}^{*} ( x , y ) r ( x , y ) ,\end{matrix} \qquad ( 1 )$$

where r(x, y) is the reference wave, o(x, y) is the object wave, and the asterisk denotes the complex conjugate. The first two terms of Eq. (1) are intensities of the reference and the object waves, respectively. They are collectively referred to as the zero-order term. The last two terms in Eq. (1) are the imaging orders—the virtual and the real one, respectively.

In the present invention, a nonlinear technique NLM is employed during reconstruction. The nonlinear technique is non-iterative and relies on the separation between the desired order and the twin image in the frequency domain. However, these orders are allowed to overlap with the zero-order. It is shown that the separation between the desired order and the twin image is one of the sufficient conditions to enable perfect suppression of the zero-order components. The other condition is that the second wave or reference wave r wave should have a higher intensity than the object wave o.

The key feature to the understanding of the nonlinear technique is the fact that the zero-order contribution to the interference intensity arises from the multiplication of the interference wave (o+r) by its complex conjugate. The multiplicative operation is converted to an additive one by using the logarithm operator. Consider the natural logarithm operator applied to both sides of Eq. (1):

$$ln [ \frac{i}{{\vert r \vert}^{2}} ] = ln [ 1 + \frac{o}{r} ] + ln [ {( 1 + \frac{o}{r} )}^{*} ] . \qquad ( 2 )$$

By using the Fourier transform and the Taylor-series development of the natural logarithm, it can be shown that if the Fourier transform of the function

$$\frac{o}{r}$$

is contained in a quadrant of the Fourier plane (for instance the first quadrant), so is the Fourier transform of

$$ln [ 1 + \frac{o}{r} ] .$$

By the same argument, the inverse Fourier transform of the conjugate term in Eq. (2) occupies the exactly opposite quadrant (i.e., quadrant three). Therefore, the desired quadrant can be retained by appropriately multiplying the Fourier transform of

$$ln [ 1 + \frac{o}{r} ]$$

with a window function. The argument is valid provided that the Taylor-series expansion is valid. In other words, it is necessary to have |r(x, y)|²>|o(x, y)|², i.e. the reference intensity must be stronger than the object in the field of view.

The idea expressed in Eq. (2) is at the core of the present invention since it shows that the equation of interference between two waves can be rearranged in order to contain only two terms, each containing information about one of the imaging orders. It also shows that perfect recovery can be achieved if the reference wave intensity is stronger than the object. It is however necessary that the two terms in the right of Eq. (2) are separated spectrally, as shown in FIG. 4b, implying that each term has to be confined in a quadrant of the Fourier plane.

After the desired order has been selected, by using for example a filter as shown in FIG. 4c, the sequence of operations must be undone by employing a set of inverse operators. Therefore, one first computes the inverse Fourier transform of the filtered signal and then subjects it to a complex exponential mapping. This results in the complex-wave:

$${o}^{′} ( m , n ) = C \cdot D ( k , l ) \{ exp [ {F}^{- 1} \{ F \{ ln [ \frac{i ( k , l )}{\vert {r ( k , l )}^{2} \vert} ] \} \cdot {1}_{[ 0 , ∞ ) \times [ 0 , ∞ )} ( {v}_{k} , {v}_{l} ) \} ] - 1 \} , \qquad ( 3 )$$

where the functions are discrete, the measurement having been quantized by the image digitizer 107. The indices m, n, k, l are integers such that

$$- \frac{M}{2} < k , m < \frac{M}{2} and - \frac{N}{2} < l , n < \frac{N}{2} ,$$

for a detector of size M×N. vₖ and vₗ are spatial frequencies defined by

$${v}_{k} = \frac{k}{N Δ x} and {v}_{k} = \frac{l}{M Δ y} ,$$

where Δx and Δy are the spatial sampling steps of the detection device 106. The symbol F denotes the Fourier transform (discrete Fourier transform in practical implementations), C is an arbitrary real constant, 1_{[0,∞)×[0,∞)} is a window function 604 for selecting the proper quadrant of the Fourier plane, and D(k,l) is a digital mask 609 to compensate for the modulation of the object complex wave 610, coming from the modulation of the reference wave induced by the off-axis configuration.

To confine the desired order to one quadrant, the carrier frequency must be chosen appropriately. The support of the quadrant mask 604 is defined by the maximum size allowed for the support in the frequency domain of the imaging order. Even though the zero-order is suppressed, there are still two terms contained in Eq. (2), corresponding to the real and virtual image. The condition of having no overlap between those two terms means that the spectrum of each term cannot go beyond the origin of the Fourier plane, thus confining each imaging order to one quadrant. This configuration makes it possible to filter easily one of the imaging terms as shown in FIG. 4c, with a quadrant filtering operation 605. This operation is defined as performing a carrier detection operation 603, which can be done automatically by locating the peak value or using an energy-based criterion, for example. The position of the carrier defines the spectral region in which is contained the imaging order, and thus defines the quadrant mask 604 to use for filtering. One should note that confining the imaging order to one quadrant of the spectrum, as required by the quadrant mask 604, enables efficient automatic filtering.

The fact that the filtered part of the spectrum is located in one quadrant implies that approximately one-half of the spectrum is used, by considering also the spectral region used by the twin-image. The second half of the spectrum can be used to record another set of signals, as it is done in multiplexed dual-wavelength holography, for example.

Eq. (3) summarizes the reconstruction algorithm of the nonlinear technique. The different operations involved in Eq. (3) are detailed in FIG. 6, giving the steps of the proposed method:
1. With a properly calibrated setup 101, it is possible to acquire the digital hologram 108 and the digital reference intensity 109. It is also necessary to calibrate beams intensity with the intensity control 103, so that the required condition |r(x, y)|²>|o(x, y)|² is fulfilled.
2. Make the division step 602 of the digital hologram 600 by the digital reference intensity 601.
3. Apply the natural logarithm operator to the result of step 2.
4. Compute the discrete Fourier transform of the result of step 3.
5. From the Fourier transform of the hologram, it is possible to perform the quadrant filtering operation 605 to select the wanted imaging order.
6. Multiply the spectrum of the result with the quadrant mask 604, to select the desired imaging term.
7. Compute the discrete inverse Fourier transform of the result of the multiplication.
8. Compute the exponential of the signal i_{F}(x, y)
9. Subtract 1.
10. In order to demodulate the hologram, a digital mask 609 D(x, y) has to be defined. This mask can be determined by centering the carrier frequency in the Fourier space, for example.

It can be deduced From Eq. (3) that, in general, the reference wave intensity is required for reconstruction. In the specific case of a plane wave reference, which is a standard assumption in holography applications, it is justified to assume that the second wave r or reference intensity is constant in the field of view. The reconstruction in this case is given by:

$${o}^{′} ( m , n ) = {C}^{′} \cdot D ( k , l ) \{ exp [ {F}^{- 1} \{ F \{ ln [ i ( k , l ) ] \} \cdot {1}_{[ 0 , ∞ ) \times [ 0 , ∞ )} ( {v}_{k} , {v}_{l} ) \} ] - 1 \} , \qquad ( 4 )$$

where

$${C}^{′} = \frac{C}{{\vert r \vert}^{2}}$$

is a real constant taking into account the constant term |r|². In this case, the division step 602 is optional. This method has the advantage of making possible to apply the proposed method without having knowledge of the reference intensity, but it will not provide perfect reconstruction, since experimental noise may induce irregularities in the reference intensity.

Since the operators involved in the proposed reconstruction technique are nonlinear, there is a risk of introducing higher harmonics in the reconstruction process. In order to suppress the harmonics to an acceptable level, the hologram can be re-sampled on a finer grid 606. This creates a bigger window for the Fourier transform and ensures that the dominant harmonics are essentially outside the spectral region of interest and that they do not get aliased to the low frequency region. Filtering can then be performed to retain the desired lowpass spectral region. In this case, it is preferable to retrieve the original sampling 607 after filtering, as shown in FIG. 6. It is also possible to further minimize the effects of the harmonics by performing a second stage of filtering 608. The eventual harmonics may be located outside of the filtered zone defined by the quadrant mask 604. It is therefore possible to suppress eventual parasitic data in this supposed null region in a second stage of filtering.

Although the window function is defined as a quadrant mask, a smaller window can also be used to segment the region of interest and to suppress out-of-band noise in the measurement stage and noise due for instance to parasitic reflections.

Because of the nonlinear operations involved in the reconstruction process, the method may be sensitive to noise, which will be increased by the logarithm operator, particularly for low intensity values. The sensitivity to noise is, however, reduced to some extent by the exponential function. The main contributions to the measurement noise come from photon noise, readout noise from the acquisition device 106, and quantization noise from the image digitizer 107. Noise reduction can dramatically increase the effectiveness of the proposed reconstruction method, and are subsequently considered. Readout noise can for instance be reduced by the use of cooled detectors or noise-free detectors, and finer quantization reduces errors induced by the image digitizer. Increasing the illumination power can reduce photon noise. One should note that increasing the illumination power does not conflict with the requirements of the presented method, since the condition |r(x, y)|²>|o(x, y)|² essentially relates to the power ratio in the two arms of the interferometer.

Another effect which can potentially degrade the quality of the proposed method is the loss of mutual coherence in the measurement plane. A reduced coherence will yield a loss in fringe visibility, which can decrease the quality of reconstruction. This effect can be compensated by ensuring a sufficient coherence, or by improving the fringe visibility during a post-processing step, where the fringe pattern can be extracted from the interferogram for improved reconstruction.

Another feature of the method is the capability of suppressing coherent noise coming from parasitic reflections on elements such as lenses. The waves generated by those elements can be seen as secondary objects, which will create intensity artifacts which can be suppressed in the same manner as the object zero-order with the proposed method.

The reconstruction method implies essentially basic mathematical operations and Fourier transforms, meaning that the design of dedicated hardware for the computation can be done, in order to improve the speed of computation. Most of those operations can also be calculated in parallel computing such as graphical processing units (GPU) or dedicated computing electronics, for example.

One should note that the proposed reconstruction method is general, in the sense that it applies to an interferometric setup in which the measurements are given by Eq. (1), and where the assumptions stated above are satisfied. It must be noted that there are no restrictions, neither on the acquisition device, nor on the type of source. The requirement of being in off-axis configuration means that it is possible to apply the invention to any type of interferometer, as Michelson, Mach-Zehnder, Mireau, Fizeau interferometer, or any interferometer provided that the configuration is in the off-axis mode. The second wave r can be also derived from the wave o or object wave itself to form a reference wave r, provided that it can be optically transformed by a device such as Beam Shaping Elements. It is an arrangement of optical systems which transforms the wavefield according to the laws of linear or Fourier optics. In its simplest conception and implementation, it can be just a shifting mirror. In a more elaborate implementation, it can be a spatial filter, which cuts the high spatial frequency components of the wavefield; a combination of both is another possibility. The example of a lateral shearing interferometer is given in the present detailed description of the invention. The intensity control between the reference and the object beams can be performed for example by using absorbing optical elements, such as neutral density filters, reflective elements, polarization optics, or any optical element providing control on the beam intensity. The proposed invention can also be employed in any acquisition regime, in the sense that the reconstruction method is independent from the camera position, provided that the camera plane intercepts the wavefield to be reconstructed. This implies that the technique can be used for high resolution reconstruction in the case of in-focus holography, Fourier holography—defined as the acquisition of a Fourier transform of the signal, performed by an optical element such as a lens—or Fresnel holography—defined as the acquisition in the region where the Fresnel approximation for beam diffraction holds.

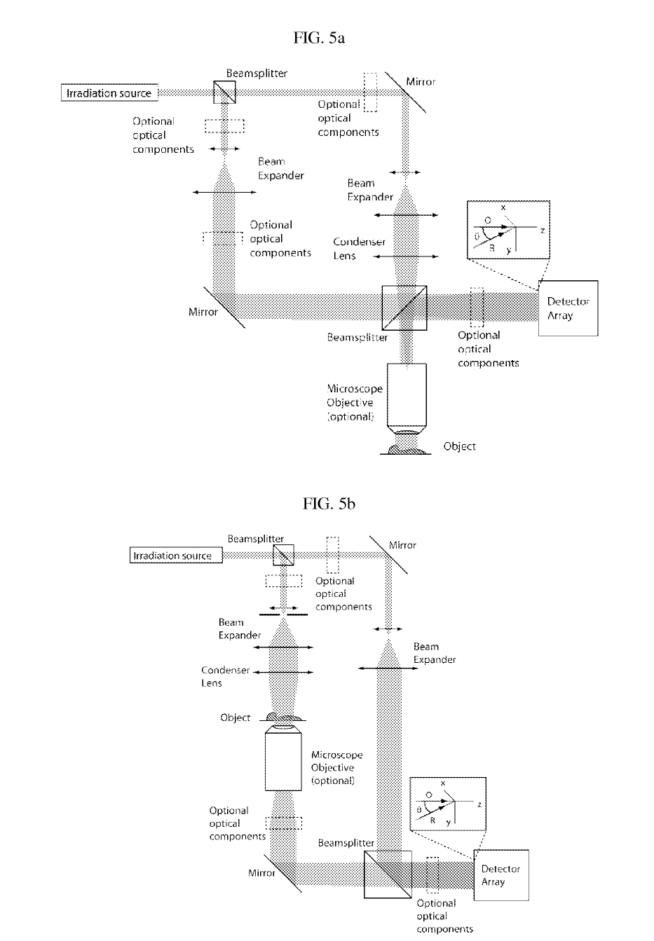

FIG. 5 shows possible practical implementations of the setup 101, in the reflection (FIG. 5a) and transmission (FIG. 5b) configurations. They are given as illustrative examples of apparatus implementing the disclosed method and their description should not place a limitation the reach of the method. It consists in this example of a Mach-Zehnder interferometer used in an imaging mode. The beam is divided in the object and reference arms. The object arm signal interacts with the sample. Beam expanders are inserted so that the beam can fill the field of view. The off-axis configuration can be established by inserting for example degrees of freedom on mirrors, which give rise to wave propagation along different directions. Finally, lenses and potentially a microscope objective can be inserted to fulfill the imaging conditions. These implementations are reported in conformity with the state of the art of Reflection and Transmission Holographic Microscopes (DHM). These apparatus are however modified to keep the ratio of the object wave intensity lower than the reference intensity.

The hologram 104 is recorded by the image acquisition device 106. The reference intensity 105 can be measured by blocking the object beam. This can be done for example by inserting a shutter in the optical path. Another solution can be to use a second detector, calibrated with the first one, measuring apart of the reference beam power.

FIG. 5c presents a configuration where the object beam is self referenced, by using beam shaping elements to generate the reference wave. FIG. 5d depicts the configuration of an imaging interferometer configuration: in this particular case a Lateral Shearing Interferometer. In this implementation, the capability of using self-emitting samples such as light emitting molecules, fluorescence or luminescence, is reported. The intensity of r can be made higher than the intensity of o by the recourse of a beamsplitter with unequal dividing ration of intensities, for example.

This kind of configuration enables an iterative reconstruction, where the ratio of the object wave and the reference wave,

$$\frac{o}{r } ,$$

can be initially obtained from the method described above and defined by Eq. (3). An estimate of the appropriate digital mask 609 gives rise to the first estimate of the object wave o⁽¹⁾. The next estimate of the object wave can be iteratively calculated by using a priori knowledge of the transformation induced on the wave by the beam shaping elements employed. The iterative reconstruction can then be expressed as:

$${o}^{( k + 1 )} = {( \frac{o}{r} )}^{( 0 )} T ( {o}^{( k )} ) , \qquad ( 5 )$$

where T is the transformation operator corresponding to the BSE.

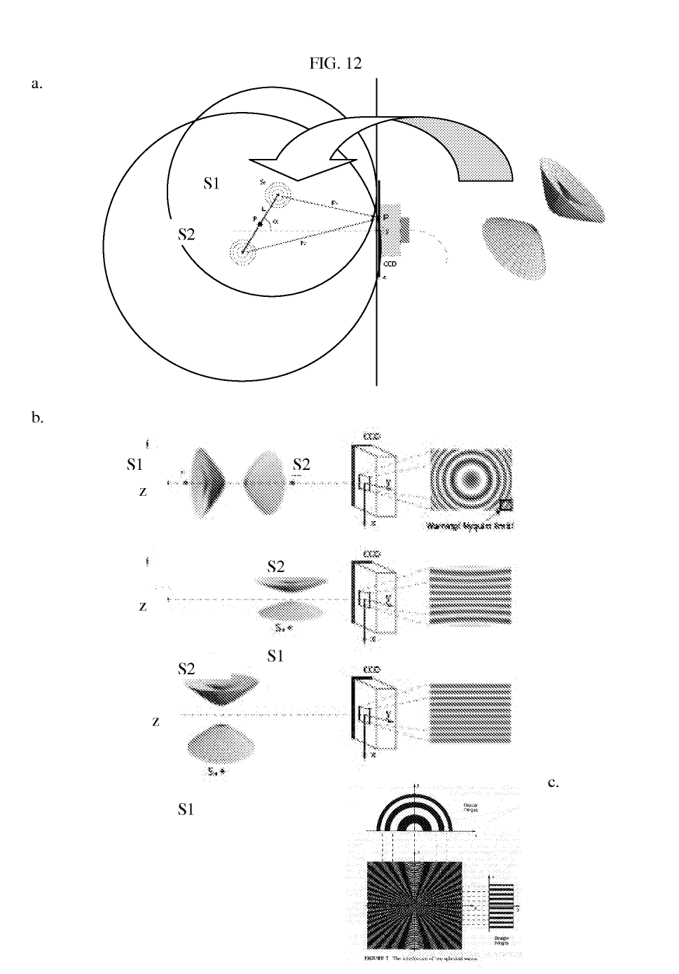

This method, in its conception, has a general reach in reconstructing the object wavefield from its interference with the reference beam in a lateral Shearing Interferometer. It has the disadvantage to be an iterative method with eventual problems of convergence or accuracy. Computing time can be also a problem. Therefore we hopefully extend the method disclosed to other algorithms and computational methods which are more direct and could give rise to real time imaging. This is the case in particular of the method illustrated in FIG. 12.

FIG. 12 illustrates the formation of the interferogram or hologram of a punctual source S in off-axis holography and in a Lateral Shear Interferometer (according to FIG. 5d); the punctual source can be a scatterer or an emitter, which generates object and reference waves as described in Eq. (6). FIG. 12a left: the image of the punctual source forms, after division of the wavefront by the beamsplitter, two punctual sources S1 and S2, which are sources of spherical waves which interfere. The result of this interference is a standing wave with minima and maxima forming hyperboloids (FIG. 12a, right) in space with the axis along S1-S2. FIG. 12b shows the limiting case where the tilt angle of the shearing mirror is zero. The role of the position of the shearing mirror or, more generally of the Beam Shaping Elements, involved in the formation of the reference wave, can be just a delay or a displacement along the optical axis z. In this case the hologram or interferogram is a Fresnel pattern. The second sketch of FIG. 12b shows the other extreme case where the axis S1-S2 is perpendicular to the optical axis z. The family of hyperboloids intercepts the detector array forming a family of hyperbola. If S1 and S2 are far enough from the detector array, the family of hyperbola becomes parallel lines, as shown in the third sketch of FIG. 12b. On the contrary, the case of S1-S2 close or touching the detector array is illustrated in FIG. 12c: the hyperboloids becomes at the limit cones intercepting the detector plane as a family of lines, the angle of which can be used to measure the distance between S1 and S2.

The method of FIG. 12 illustrates the possibility to analyze directly the hologram or interferogram obtained in an on-axis or in-line as well as off-axis configuration. On-axis or in-line configuration appears as the limit case of the off-axis configuration: the case where the tilt of both mirrors of a Michelson interferometer or a shearing interferometer is zero. The interference pattern is a Fresnel pattern in this case. From the state of the art, it is known that reconstruction of the wavefront can be achieved by deconvolution or wavelet analysis: the particular wavelet used for this application are the Fresnelets which constitute a Riesz basis (M. Liebling, T. Blu and M. Unser, “Fresnelets: New multiresolution wavelet bases for digital holography”, IEEE Transactions on Image Processing, 12, 29-43 (2003). The Fresnelet decomposition can therefore be applied to the determination of the position of the point source along the z-axis. However, it is not possible in this case to distinguish between point sources situated on one side or on the other side of the detector array. Only phase shifted second wave or reference wave can help to discriminate.

The following approach is disclosed; considering the scheme of FIG. 5d, it must be observed that:

1. Without tilting any of the mirrors, and by displacing at least one of the mirrors along its axis, it is possible to obtain the two images of the point source exactly in the position shown in the first sketch of FIG. 12b. The interfering pattern is therefore a Fresnel pattern in the direction perpendicular to S1-S2, on the detector array and with a spacing inversely related to their separation distance and their distance to the detector.

2. By tilting at least one of the mirrors by an angle and maintaining the optical path lengths equal by adjusting the mirror position along their axis, it is possible to obtain the two images of the point source exactly in the position of the second or third sketch of FIG. 12b. The interfering pattern is therefore approximately straight lines in the direction perpendicular to S1-S2 and with a spacing inversely related to their separation distance and their distance to the detector.

$$o = \frac{exp ( - i k {δ}_{1} )}{{δ}_{1}} and r = \frac{exp ( - i k {δ}_{2} )}{{δ}_{2}} \\ with {δ}_{1} = z \sqrt{( 1 + {ρ}_{1}^{2} / {z}_{1}^{2} )} and {δ}_{2} = {z}_{2} \sqrt{( 1 + {ρ}_{2}^{2} / {z}_{2}^{2} )} \\ and {ρ}_{1} = \sqrt{{( x - {x}_{1} )}^{2} + {( y - {y}_{1} )}^{2}} and \\ {ρ}_{2} = \sqrt{{( x - {x}_{2} )}^{2} + {( y - {y}_{2} )}^{2}} , \qquad ( 6 )$$

where x₁, y₁, z₁ and x₂, y₂, z₂ are the coordinates of S1 and S2.

where x₁, y₁, z₁ and x₂, y₂, z₂ are the coordinates of S1 and S2.

A wavelet analysis within the diffraction spot of the intercept of the image of the point source provides a precise measurement of the distance of the point source pair to the detector and therefore the exact distance from the plane of the pair of point sources, which allows to situate them in the third dimension. The wavelet approach is one preferred method to perform a space-spatial frequency analysis, since it is a method capable of achieving a spatial frequency demodulation.

In particular, a multi-resolution decomposition in term of a wavelet decomposition based on the Riesz transform, being a 2D generalization of the Hilbert transform, will provide decomposition of the point sources in depth.

From the computed value of o/r and taking into account the particular expression of the wave generated by the point source which is a spherical wave, it is possible to compute o/r from the expression of the spherical waves and to make:

1. a deconvolution whereby the position of the pair S1 and S2 is located precisely in 3D, the core of the convolution integral being the expression of o/r computed for one point source.

2. a wavelet decomposition of the said ratio o/r. The wavelet analysis of on-axis and off-axis configuration can be performed with Fresnelets or wavelet decomposition based on the Riesz transform, being a 2D generalization of the Hilbert transform

The advantage of the method is that it is a direct computing method which can be possibly used in real time for location of point sources in 3D at the nanoscale.

Two off-axis configurations or a plurality of off-axis configuration of the interferogram provide an ambiguity free 3D images of object containing point scatterers and photon emitting molecules.

It is also worth to mention that this analysis of the density of particles in depth can also provide a mean to obtain a full tomographic image of the specimen containing the point sources by the recourse to the state of the art methods of tomographic reconstruction with state of the art methods such as, for example, Radon transform and Fourier slice theorem. The method can be applied to locate precisely molecular emitters and give a 3D image of distributed fluorescent or luminescent specimens.

The advantages of the disclosed method will appear more clearly from the given illustrations. The main advantage of the proposed method is the resolution improvement after reconstruction, thanks to the enlarged bandwidth of the imaging terms. The downside of the state-of-the-art filtering methods for off-axis holography is that they are not efficient in term of utilizing the signal bandwidth. This drawback is illustrated in FIG. 4. In order to separate the various diffraction orders, high modulation frequencies are required. This choice, however, requires finer sampling, which calls for sophisticated hardware. If sampling is not sufficiently fine, there will potentially be aliasing, which can lead to degradation in the reconstructed image quality. Thus, although in principle, the choice of a high carrier frequency is justified, in practice, the hardware limitations introduce a restriction on the achievable resolution. The modulation frequency can be decreased, but this leads to spectral overlap among the various orders and thereby loss of signal information.

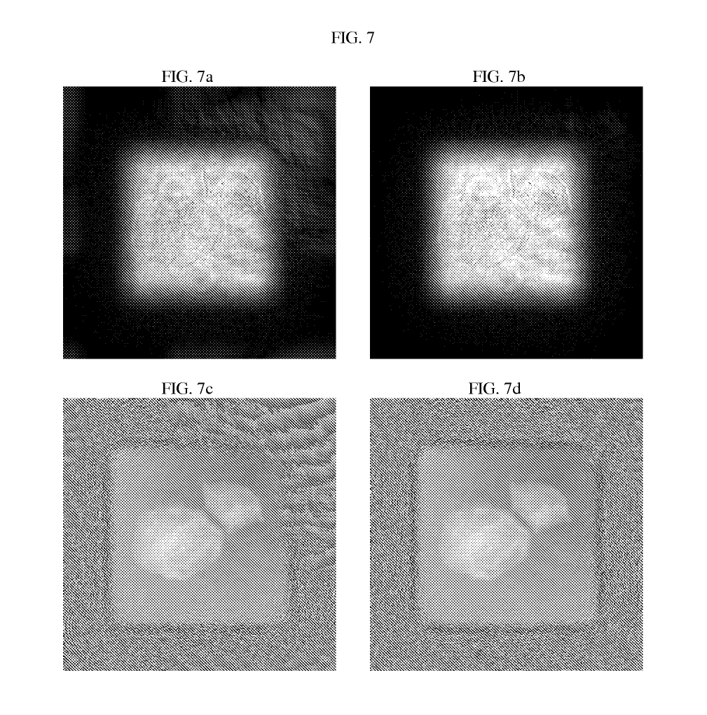

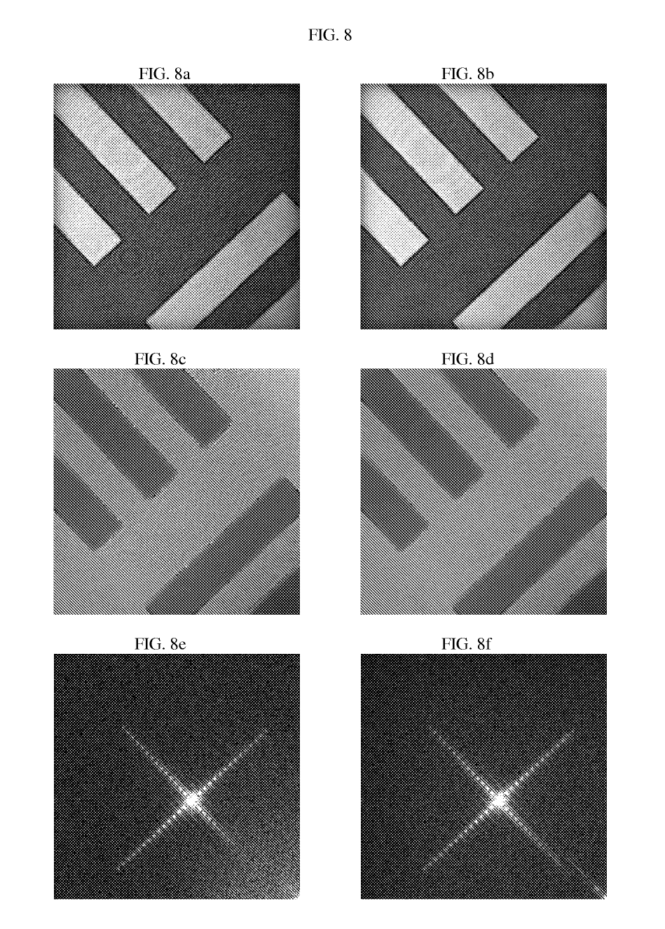

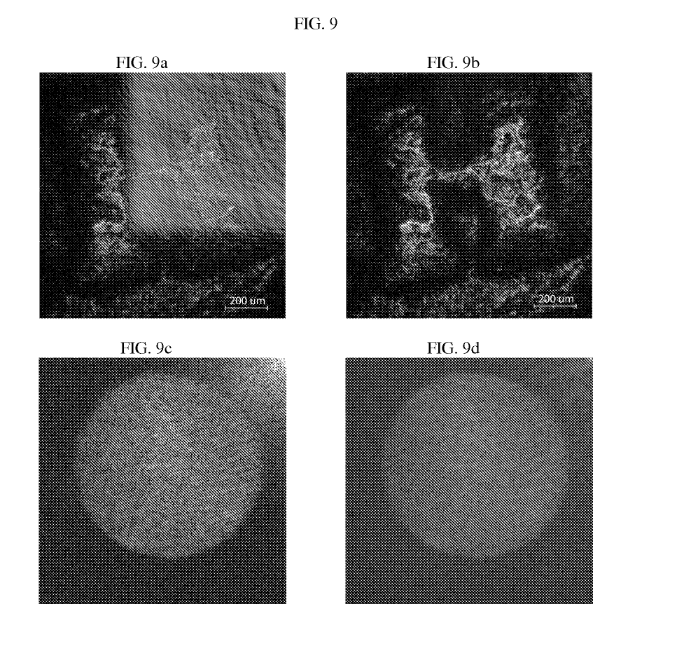

FIG. 7, FIG. 8 and FIG. 9 show proof of principle of the proposed invention. Measurements were made in the Fresnel region in transmission and reflection configurations, respectively. FIG. 7 presents results on a biological cell, specifically the amplitude (FIGS. 7a and 7b) and phase (FIGS. 7c and 7d) images. In the case of the classical reconstruction (FIGS. 7a and 7c), zero-order artifacts can readily be seen in the upper-right corner, showing that it was not possible to induce an angle in the off-axis configuration sufficient to spatially separate the orders. The zero-order gives rise to incorrect values in amplitude, and a modulation term in both signals. Those artifacts are suppressed by using the nonlinear method, as shown in FIGS. 7b and 7d. In this case, no post-processing step 608 was applied. FIG. 8 presents measurements of an USAF target, measured in reflection configuration. By comparing the standard reconstruction method (FIGS. 8a and 8c) and the proposed reconstruction (FIGS. 8b and 8d), the improvement in quality can readily be seen both in amplitude (FIGS. 8a and 8b) and phase (FIGS. 8c and 8d) images. The selected quadrant of the Fourier plane is then presented for state-of-the-art filtering (FIG. 8e) and the nonlinear methods (FIG. 8f), showing the attenuation of the unwanted frequencies by using the nonlinear reconstruction. FIG. 9 is a demonstration of use of the nonlinear method for rough samples, where a letter on a coin has been measured in reflection. In this case, the zero-order artifact is clearly identifiable in the standard reconstruction in FIG. 9a, which is suppressed by employing the nonlinear method, as shown in FIG. 9b. The relevant quadrant of the spectra of the reconstructions are shown in FIG. 9c and FIG. 9d, respectively for the standard and nonlinear method, showing that the zero-order is suppressed in the latter case.

When experimental noise is not negligible in the acquisition process, or when the intensity ratio between the reference wave and the object wave is not large enough to provide perfect reconstruction, it can happen that the proposed invention does not suppress totally the zero-order term. In the following paragraphs, a method enabling further improved suppression in those cases is proposed. It is possible to enhance the zero-order suppression by introducing an iterative loop in the digital object wave reconstruction, so that the remnants of the zero-order can be removed by further iterations. The principle behind the iterative algorithm is described in the following paragraphs.

The measurements in interferometry and holography are intensities; the associated phase information is neither directly available nor measurable. The problem in complex-wave reconstruction is to recover the phase from the intensity measurement. The non-iterative algorithm proposed above and in FIG. 6 accomplishes this goal in a non-iterative fashion. In this part of the invention, we propose an iterative algorithm to recover the phase from the magnitude of the complex wavefield. The principle behind the iterative algorithm is successive refinement of phase starting from the measured intensity. The phase initialization can be all zeros/random. The input for the iterative algorithm is the logarithm of the square root of the measured intensity (henceforth, referred to as the log-magnitude). In each iteration, two constraints are imposed: first, the condition that the desired imaging order occupy one quadrant in the spectrum—this is satisfied by selecting the desired quadrant by multiplying with a suitable window function; and second, the constraint that the log-magnitude of the corresponding spectrum equal the magnitude derived from the measurements. These two conditions ensure that, upon convergence, the phase corresponding to the measurements is obtained. The iterative algorithm also allows for incorporating a denoising step in the loop. Therefore, simultaneous denoising and reconstruction can be achieved in the same method. The iterative technique is motivated by phase-retrieval algorithms developed by J. R. Fienup in “Reconstruction of an object from the modulus of its Fourier transform,” Opt. Letters, 3, 27-29 (1978). The main difference, however, is that in the proposed invention the log-intensities are used instead of the intensities and a possibility for incorporating a denoising step in the iterations is also indicated. As a result, the steps in the iterative technique are also accordingly modified.

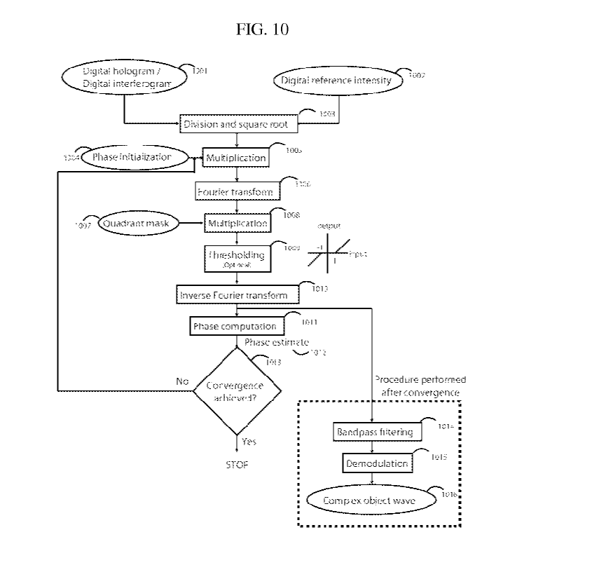

The flowchart shown in FIG. 10 illustrates the steps in the iterative technique for complex object-wave reconstruction. The digital hologram i(x, y) 1001 is divided by the digital reference intensity |r(x, y)|² 1002 to obtain normalized hologram intensity. The result is subject to a natural logarithm operation 1003. This step results in the logarithm of the intensity log [i(x, y)/|r(x, y)|²]. Henceforth, this quantity shall be referred to as the log-intensity. The log-intensity is divided by a factor of two in order to obtain the log-magnitude. A constant offset c is added to make the log-magnitude positive everywhere. The phase initialization 1006 φ⁽⁰⁾(x, y) can be all zeros or random. The addition 1007 corresponds to the operation: ½ log [i(x, y)/|r(x, y)|²]+jφ^{(k)}(x, y) where φ^{(k)}(x, y) is the phase after iteration k, and j=\sqrt{−1}. The Fourier transform (operator shown in 1008) of the sum is then computed. Since the desired imaging order occupies only one out of four quadrants, multiplying with a suitable window function retains it. The window function is the quadrant mask 1009, whose design is given in FIG. 4c. The desired quadrant is selected by multiplication 1010. An optional soft-threshold operation 1011 is used to suppress low-level noise. Only the magnitude of the input is considered for thresholding. The phase is retained as is. The input-output characteristics of the threshold are shown next to 1011. The threshold value T is chosen as a multiple of the standard deviation of the noise (typically, twice the standard deviation of the noise). The noise standard deviation can be estimated from the low-energy quadrants. The threshold operation is optional and is not necessary if the experimental noise level is negligible. The inverse Fourier transform operator 1012 is then applied to the thresholded wave. The result is again complex-valued and therefore has both magnitude and phase. Specifically, the phase is of interest and it is computed by a standard arc-tangent routine 1013. The phase estimate 1014 is an improvement over the initialization in 1006 and is retained for further use in the next iteration. The magnitude after 1012, however, is different from the positive log-magnitude derived directly from the measurement (after 1005). Therefore, it is replaced by the magnitude obtained after 1005. Thus, in the next iteration, the positive log-magnitude from the measurement is used together with the updated phase 1014. The iterations are repeated until a suitable convergence criterion 1015 is satisfied. The criterion for determining convergence can be a limit on the number of iterations, for example. Alternatively, the criterion can also be a relative difference between two successive phase estimates. It can be shown that, under some technical conditions (H. H. Bauschke, P. L. Combettes, D. R. Kuke, “Phase retrieval, error reduction algorithm, and Fienup variants: a view from convex optimization,” J. Opt. Soc. Am. (A), 19, 1334-1345 (2002), the algorithm converges. Thus, this procedure allows for recovering the phase from the intensity measurements.

After convergence, the following procedure is adopted to compute the complex-valued object wave. The result after 1012 is taken and subject to a complex exponential operation exp(.), denoted in 1016, which raises the Neperian base e to the power of the input value. In the absence of noise and thresholding, this results in a complex wave of the type e^{C}(1+o(x, y)/r(x, y)), where C is the constant used to render positive all log-magnitude values. The constant is suppressed by dividing the complex-wave amplitude by e^{C} 1017. The DC term and high-frequency noise are suppressed by standard bandpass filtering 1018. The demodulation operation 1019 is standard and essentially shifts the bandpass spectrum such that it is centered at the origin. The bandpass filter and demodulation operations are typically implemented jointly in the Fourier domain as a sequence of the following operations: (i) computing the Fourier transform, (ii) bandpass spectrum selection, and (iii) demodulation by shifting the bandpass spectrum to have its center at the origin. This procedure gives rise to the complex object wave 1020.

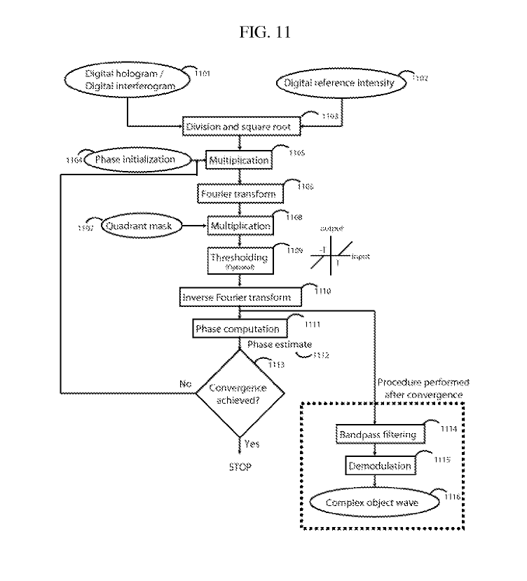

A variant of the proposed iterative technique is shown in FIG. 11. In this variant, the phase associated with the magnitude spectrum is computed iteratively starting from the intensity measurement instead of the log-intensity. The philosophy behind the two algorithms is the same, namely, successive refinement of phase from the measured magnitude. A somewhat similar technique was proposed in the patent WO 2007/131650. However, the method proposed in this application differs significantly in the implementation, since it aims essentially at using the reconstructed signal in a feedback loop with a spatial light modulator. A summary of the various steps is given below.

The measured hologram intensity 1101 is divided by the measured reference intensity 1102 and then the square-root 1103 of the result is computed in order to obtain the magnitude \sqrt{i(x, y)/|r(x, y)|²}. The phase initialization 1104 φ⁽⁰⁾(x, y) can be all zeros or random. The multiplication in 1105 corresponds to the operation \sqrt{i(x, y)/|r(x, y)|²}exp(jφ^{(k)}(x, y)) where φ^{(k)}(x, y) is the phase after iteration k. The rest of the operations 1106-1113 are the same as the operations in 1008-1015. The operations 1114-1116 are identical to the ones in 1118-1120. The end product of the iterative algorithm is the complex wave 1116.

1. A method for computing the complex wavefield of a wave, by means of measuring the intensity signal resulting from the interference of the said wave, hereby called “object wave” o, with a second wave, hereby called “reference wave” r, and comprising:
a. The generation of said object wave,
b. The generation of said reference wave having some non vanishing mutual coherence with the said object wave,
c. The production of an interference wave between the object and reference wave,
d. The measurement with a detector array of the intensity of the said interference wave,
e. The calibration e and the control of the intensity of the object wave or the intensity of the reference wave, in order to keep the ratio of the intensity of the said object wave to the intensity of the said reference wave smaller than unity,
f. A calculation method consisting in computing the logarithm of the normalized intensity of the interference wave, calculated as the ratio of the intensity of the interference wave to the intensity of the second wave,
g. A calculation method consisting in computing the complex 2D Fourier transform of the logarithm of the normalized intensity of the interference wave measured on a plane intercepting the said wave,
h. An algorithm to retrieve the complex ratio of the said object wave complex amplitude to the said reference wave complex amplitude,
i. A calculation method to provide the 3D distribution of the complex amplitude of the said object wave.

2. A method according to claim 1, where the said object wave is generated by the scattering by an object of the wave emitted by an external source.

3. A method according to claim 1, where the said object wave is generated by an object incorporating the said external source or confounded with the said external source.

4. A method according to claim 2, where the said reference wave is generated by a system propagating or optionally transforming the wave emitted by the said external source of claim 2, by means of beam shaping elements.

5. A method according to claim 2, where the said reference wave, is generated by a system propagating or optionally transforming the wave confounded with the said object wave of claim 2, by means of beam shaping elements.

6. A method according to claim 4, where the Beam Shaping Elements are any or a combination of the following optical elements: mirrors, beam splitters, components which change the space-bandwidth characteristics of the beam such as lenses (spherical, aspherical, cylindrical lenses), prisms, diaphragms, pinholes, forming spatial filters, diffracting elements, like gratings, and combinations of these components.

7. A method according to claim 4, where the interference wave formed on a plane intercepting the said object wave, is a hologram.

8. A method according to claim 1, where the spatial and temporal coherence of the source is designed and controlled in order that the mutual coherence between the object and the reference wave provides in a preferred embodiment a full cover of the detector array.

9. A method according to claim 1, where the algorithm of point h of claim 1 comprises the following steps:
a. Select the wanted imaging order,
b. Define a digital mask by centering the carrier frequency in the Fourier domain,
c. Multiply the spectrum of the result with the quadrant mask, to select the desired imaging term corresponding to the selected diffraction order,
d. Compute the inverse Fourier transform of the result of point c,
e. Compute the exponential of the distributed signal obtained in d,
f. Subtract 1.

10. A method according to claim 1, where the algorithm of point i of claim 1 comprises the following steps:
a. Multiply the complex ratio calculated by the reference wave complex amplitude according to a model incorporating the calibration data and the adjusted phase distribution (corresponding the demodulation of the said complex ratio),
b. Propagate the wavefield around the measurement plane, enabling recovery of the 3-dimensional information of the object. This propagation can be done, for instance in the case of optical fields, with the Fresnel-Kirchhoff integral, Huygens-Fresnel integral, or any of the Fresnel approximation provided by Fresnel transform, or any of the Fraunhofer approximations expressed using Fourier transform.

11. A method according to claim 1, where the algorithm of point i of claim 1 is the following optional algorithm which comprises the optional following steps:
a. Multiply the complex ratio calculated by the reference wave complex amplitude according to a model incorporating the calibration data and the adjusted phase distribution. (corresponding the demodulation of the said complex ratio),
b. Take the result of point a. as a the estimation of the object wave complex amplitude at step k=0,
c. Estimate the object wave complex amplitude at step k=k+1 by multiplying the complex ratio calculated according to claim 9 by the estimation at step k of the object wave complex amplitude, propagated or transformed according to claim 5, by the means of beam shaping elements, and obtain the new estimation of the object wave complex amplitude at step k+1,
d. Iterate to point c., till the difference between estimation at step k+1 and at step k is less than a threshold arbitrarily given by an estimated deviation of the result,
e. Propagate the wavefield around the measurement plane, enabling recovery of the 3-dimensional information of the object, and the propagation can be done, for instance in the case of optical fields, with the Fresnel-Kirchhoff integral, Huygens-Fresnel integral, or any of the Fresnel approximation provided by Fresnel transform, or any of the Fraunhofer approximation provided by Fourier transform.

12. A method according to claim 1, where the object is composed of a plurality of point sources: scattering centers or photon emitting molecules, and where the algorithm of point i of claim 1 comprises the optional following steps:
a. Decomposing the complex ratio calculated, i.e. o/r, according to one of the following method:
I. a deconvolution whereby the position of the pair S1 and S2 is located precisely in 3D, the core of the convolution integral being the expression of o/r computed for one point source,
II. a wavelet decomposition of the said ratio o/r. The wavelet analysis of on-axis and off-axis configuration can be performed with Fresnelets or a wavelet decomposition based on the Riesz transform, being a 2D generalization of the Hilbert transform,
III. any other method permitting the localization of the point source in 3D. The advantage of the method is that it enables a direct computing method which can be possibly used in real time for location of point sources in 3D at the nanoscale the interferogram provides an ambiguity free 3D images of the object with the distribution of point scatterers and/or photon emitting molecules,
and this analysis of the density of particles in depth can also provide a mean to obtain a full tomographic image of the specimen containing the point sources by the recourse to the state of the art methods of tomographic reconstruction such as, for example, Radon transform and Fourier slice theorem, and
the method a. can be applied to locate precisely molecular emitters and give a 3D image of distributed fluorescent or luminescent specimens,
b. A combination of the wavelet analysis of the interferogram in an on-axis and off-axis configuration provides an ambiguity free 3D images of object containing point scatterers and photon emitting molecules,
c. In an alternative implementation, two off-axis or a configuration with a plurality of off-axis configurations of the interferogram provides an ambiguity free 3D images of objects containing point scatterers and photon emitting molecules,
d. Point b. and c. can contribute to form a full tomographic image of the specimen containing the point source as well.

13. A method according to claim 1, where the algorithm of point h of claim 1 comprises the following optional complementary steps with the target of incorporating simultaneous denoising and reconstruction in the same method, and which comprises the following iterative algorithm:
a. The log-intensity is divided by a factor of two in order to obtain the log-magnitude,
b. A constant offset c is added to make the log-magnitude positive everywhere,
c. The phase φ^{(k)}(x, y) is considered in the full complex expression after k steps of iteration of the log-magnitude: ½ log [i(x, y)/|r(x, y)|²]+jφ^{(k)}(x, y) with j=\sqrt{−1},
d. The phase initialization φ⁽⁰⁾(x, y) can be all zeros or random,
e. The Fourier transform of the sum is then computed,
f. Multiply by the quadrant mask,
g. Optional soft-threshold to suppress low-level noise (optional),
h. The threshold value T is chosen as a multiple of the standard deviation of the noise,
i. Inverse Fourier transform applied to the thresholded wave,
j. Iterate: return to c. till convergence criterion is reached: criterion can be a relative difference between two successive phase estimates,
k. Complex exponential operation: provides estimation of e^{C}(1+o(x, y)/r(x, y)),
l. Computation of o(x, y)/r(x, y).

14. A method according to claim 1, where the source is an electromagnetic wave source.

15. A method according to claim 14 where the detector measuring the interference wave or the hologram is an electronic camera.

16. A method according to claim 1, where the imaging interferometer is of any type, such as the one from the non exhaustive list including Michelson, Twyman-Green, Mach-Zehnder, and a combination of them, modified to keep the ratio of the object wave intensity to the reference wave intensity below unity.

17. A method according to claim 16, where the interference can be performed with multiple said reference waves, allowing multiplexing the information on the full bandwidth of the detector.

18. A method according to claim 16, where the interferometer is a Mach-Zehnder type interferometer.

19. A method according to claim 16, where the interferometer is a Transmission Digital Holographic Microscope modified to keep the ratio of the object wave intensity to the reference wave intensity below unity.

20. A method according to claim 16, where the interferometer is a modified Mach-Zehnder type, including a Michelson type interferometer capturing the beam reflected by the object.

21. A method according to claim 16 where the interferometer is a Reflection Digital Holographic Microscope modified to keep the ratio of the object wave intensity to the reference wave intensity below unity.

22. A method according to claim 1, where the imaging interferometer is of any type, such as the one from the non exhaustive list including lateral or radial shearing interferometers and Sagnac, or a combination of them, modified to keep the ratio of the object wave intensity to the reference wave intensity below unity.

23. A method according to claim 21, where the interferometer is a lateral shearing interferometer.

24. A method according to claim 1, where the source is a matter wave, such as an electron or ion beam.

25. A method according to claim 1, where the source is an acoustic wave source.

26. A method according to claim 1, where the spatial bandwidth is extended to a full quadrant of the spatial frequency domain, overall limited by the maximum wavevector propagating in the medium at the selected wavelength.

27. A method according to the claim 26, where the image resolution and therefore the image quality are improved according to the extended bandwidth.

28. A method according to claim 1, where the interferogram or the hologram is acquired in one shot, i.e. in a time duration given either by the detector or the camera acquisition time or by the duration of the source emission: laser pulse if the source is optical.

29. A method according to claim 1, where the reference intensity is recorded simultaneously with the hologram or interferogram, by the use of a second detector array.

30. A method according to claim 1, enabling the suppression of the coherent noise coming for instance from interference of parasitic reflections.

31. A method according to claim 1, where the computational operations involved in the reconstruction process can be implemented in specifically dedicated hardware, such as graphical processing units, for example.

32. Apparatus using the method of claim 1.
